(19) United States
(12) Patent Application Publication
(10) Pub. No.: US 2022/0280976 A1
(43) Pub. Date: Sep. 8, 2022

(54) Sieve Separator, Grinding Equipment for Powder Coatings and Process of Cleaning a Sieve Separator

(71) Applicant: Akzo Nobel Coatings International B.V., Amsterdam (NL)

(72) Inventors: Steve Thompson, Durham Durham (GB); Jonathan Scherrer, Saint Cyr Sous Dourdan (FR)

(21) Appl. No.: 17/636,468

(22) PCT Filed: Aug. 17, 2020
(86) PCT No.: PCT/EP2020/072961

§ 371 Date: Feb. 18, 2022

(30) Foreign Application Priority Data
Aug. 19, 2019 (EP) 19192258.2

(51) Int. Cl. B07B 1/55

(52) U.S. Cl. CPC B07B 1/55

(57) ABSTRACT

A sieve separator (8) comprising: an upstream chamber (9) comprising an inlet (16a) and an outlet (16b); a downstream chamber (11) comprising an outlet (12); a sieve (13) separating the upstream chamber (9) and downstream chamber (11) and having an upstream surface facing the upstream chamber and a downstream surface facing the downstream chamber; and nozzles (22) for supplying pressurized cleaning gas to the upstream chamber (9) and downstream chamber (11), wherein the nozzles (22) are positioned in the peripheral side wall of the upstream chamber (9) and the peripheral side wall of the downstream chamber (11) and are oriented to create a gas flow along the upstream surface and the downstream surface of the sieve (13).

The present disclosure relates to a sieve separator, in particular for sieving ground powder coatings. The invention also relates to grinding equipment including such a sieve separator and to a process of cleaning such a sieve separator.

In the manufacturing of powder coatings, granules of a polymer binder material are mixed with hardener, pigments and other powder ingredients and subsequently heated and extruded. The extruded mixture is rolled flat, cooled and broken into flakes, which are subsequently ground and milled in a grinder to form a powder. The resulting powder has a broad range of particle sizes. In a first step the particles that are too small (the so-called “superfines”) are separated, typically by cyclonic separation. In a next step, the oversized particles are separated, typically by a sieve separator. The oversized particles can be returned to the grinder or processed as waste.

Subsequent batches of powder coatings may differ in colour, composition and/or particle size distribution. After the production of a batch, the process equipment needs to be thoroughly cleaned before the production of a next batch of a different colour or chemistry can start.

In particular, the sieve separator may contain residues of a prior batch which can cause significant deviations of the desired colour in the final powder product. To clean the sieve separator, the device must be dismantled manually. This is laborious and ergonomically difficult work, which significantly increases standstill time of the processing equipment. Cleaning of the sieve separator typically takes from 15-30 minutes.

CN202984093U discloses a system for cleaning screens used in a flour factory, using a pulse control valve to flush the screen with air. The air is jetted upwardly through the screen. The jets mainly clean the screen where they cross the screen and do not provide the degree of overall cleaning as required in a powder coating production environment.

Flushing screens by a back flow of a cleaning gas is for instance disclosed in JP2006075722. Such systems are used to clean a screen as such, rather than a sieve separator as a whole, including upstream and downstream chambers encasing the sieve.

It is an object if the invention to reduce standstill time during cleaning of a sieve separator without reducing cleaning effectivity.

The object of the invention is achieved with a sieve separator comprising:
an upstream chamber (9) comprising an inlet (16a) and an outlet (16b);
a downstream chamber (11) comprising an outlet (12);
a sieve (13) separating the upstream chamber (9) and downstream chamber (11) and having an upstream surface facing the upstream chamber and a downstream surface facing the downstream chamber; and
nozzles (22) for supplying pressurized cleaning gas to the upstream chamber (9) and downstream chamber (11), wherein the nozzles (22) are positioned in the peripheral side wall (14) of the upstream chamber (9) and the peripheral side wall (18) of the downstream chamber (11) and are oriented to create a gas flow along the upstream surface and the downstream surface of the sieve (13).

In this system the separator does not need to be opened and dismantled for cleaning. The sieve separator can be cleaned in a fast and efficient manner. The standstill time can be reduced to 8 minutes or even less. This way of cleaning is also a substantial improvement for the health and safety of the operator.

The upstream chamber and downstream chambers comprise a peripheral wall encasing the sieve. The peripheral wall of the upstream chamber and downstream chamber typically has a circular cross-section, i.e. is round or oval shaped. In other words, typically the upstream chamber and downstream chamber comprise a cylindrical peripheral side wall.

The sieve separator comprises nozzles at the upstream and downstream sides of the sieve, along the circumference of the sieve, e.g., in the peripheral wall encasing the sieve. This facilitates efficient cleaning of both sides of the sieve in the upstream chamber as well as in the downstream chamber. The nozzles may be orientated to create a swirling gas flow along the upstream surface and downstream surface of the sieve.

The sieve separator may comprise a control unit configured to control the nozzles to supply the cleaning gas independently and optionally pulse-wise. The control unit can be configured to control the nozzles independently, simultaneously and sequentially, e.g., according to programmed patterns. The control unit can for example control direction, duration and/or flow velocity of the pulses, and/or sequence of activation of the nozzles. Different programs can be selected for different situations. For example, if two consecutive batches have strongly contrasting colours, an intensive program can be run with stronger and/or longer pulses than would be used between two batches of slightly differing colours. A suitable program may for example be selectable by an operator via a suitable user interface.

The duration of the individual pulses may for example be at least one second, e.g., up to about 10 seconds. The flow of the jets can be regulated, if needed.

The nozzles can be rotated in any direction (360°).

To obtain an effective swirl, the nozzles can be mainly oriented in a direction substantially parallel to the sieve.

Alternatively, the nozzles can be slightly tilted in the axial direction. Slightly tilted means a tilt in the axial direction provided the nozzles are directed towards an opposite part of the peripheral wall of the upstream or downstream chamber.

The nozzles can have the same orientation or they can have different orientations, relative to the central axis through the sieve.

Further, the nozzles may be orientated in a tangential or radial direction relative to a central axis of the sieve, or at any angle in between.

The nozzles can be evenly spaced and can be of the same type and size. In alternative embodiments, different types of nozzles and/or different arrangements can be used, e.g., to create specific patterns of vortices.

Optionally, the inlet of the upstream chamber is also the outlet, wherein the inlet/outlet comprises a valve selectively moveable between an inlet position (allowing powder coating to enter the sieve separator) and an outlet position (allowing discharge of powder dislodged from the surface of the sieve).

As mentioned above, the inlet in the upstream chamber is for supplying powder coating and an outlet in the upstream chamber is for discharging cleaning gas. Any powder dislodged from the sieve will also be discharged via the outlet together with the cleaning gas.

Optimally, the upstream chamber comprises a second inlet, and optimally this second inlet comprises a valve. The value would be closed during sieving operation, but open during cleaning to allow air flow and prevent a vacuum being made inside the sieve. It has been found that air flow through the second inlet further enhances the cleaning of the sieve.

The sieve separator is typically used in combination with a grinder for milling the powder coatings. The milled powder coatings material is transported via a conduit fluidly connecting the outlet of the grinder to the inlet of the upstream chamber of the sieve separator. Typically, the inlet of the upstream chamber is also the outlet of the upstream chamber and this conduit comprises a cyclone separator for separation of the superfines, the superfines being removed from the sieve separator via the outlet during cleaning. In the cyclone separator, a vortex is created in the passing gas flow, centrifugally separating the light superfines from the heavier powder coating particles. The superfines are discharged via an exhaust to a further filter station, e.g., with filter bags, while the larger particles leave the cyclone via an outlet and may be returned to the upstream chamber of the sieve separator or is removed as waste. During cleaning, the pulsed cleaning gas is discharged from the upstream chamber in the reverse direction via the outlet in the upstream chamber. When the inlet in the upstream chamber is also the outlet, the spent cleaning gas flows into the cyclone separator carrying the oversized particles separated by the sieve. Accordingly, the cyclone defines a discharge flow path for used cleaning gas leaving the upstream chamber of the sieve separator. Eventually the cleaning gas is discharged via the same exhaust as used for discharging the superfines.

Accordingly, one embodiment of the invention is equipment for grinding powder coatings comprising
a grinder comprising an outlet,
a sieve separator as herein described, and
a conduit fluidly connecting the outlet of the grinder to the inlet of the upstream chamber of the sieve separator.

Optionally, the inlet in the upstream chamber of the sieve separator is the outlet in the upstream chamber, and the conduit comprises a cyclone separator. Said cyclone separator may define a discharge flow path for used cleaning gas leaving the upstream chamber of the sieve separator.

The downstream chamber of the sieve separator may comprise an outlet with a valve, selectively moveable between a sieving position (default position), allowing discharge of sieved powder coatings to a filling station, and a cleaning position, allowing discharge of used cleaning gas. The used cleaning gas can from example be discharged to the same downstream filter stations as the superfines leaving the cyclone separator.

Another embodiment of the invention is a process of removing particles from a sieve separator as herein described, comprising:
(a) jetting cleaning gas over the upstream surface and downstream surface of the sieve from nozzles in the upstream chamber and the downstream chamber, and
(b) removing particles and cleaning gas via the outlet in the upstream chamber (9) and the outlet in the downstream chamber.

Optimally, the cleaning gas is jetted through different nozzles according to programmed patterns, e.g. pulse wise.

The above-described aspects will hereafter be more explained with further details and benefits with reference to the drawings showing an exemplary embodiment.

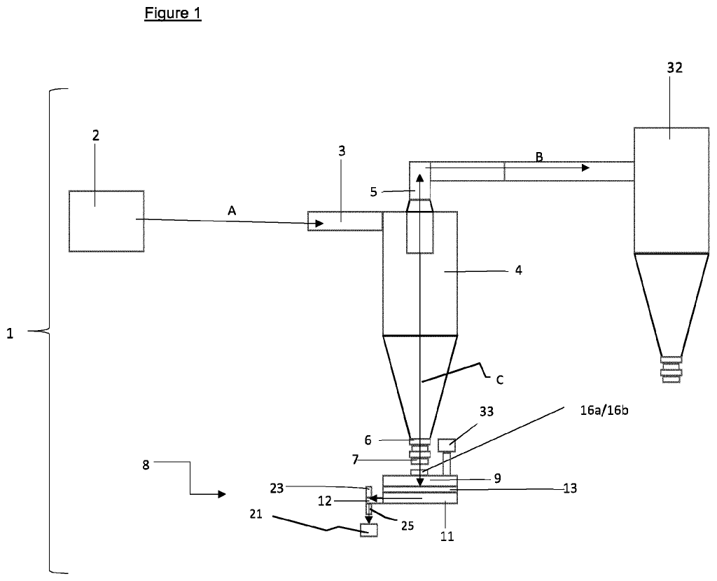

FIG. 1: schematically shows equipment for processing grinded powder coatings;

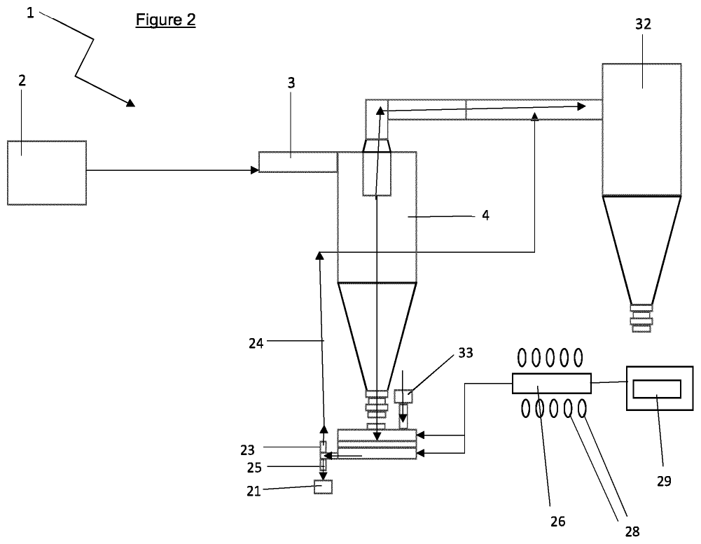

FIG. 2: schematically shows the equipment of FIG. 1 during a cleaning process of the present disclosure;

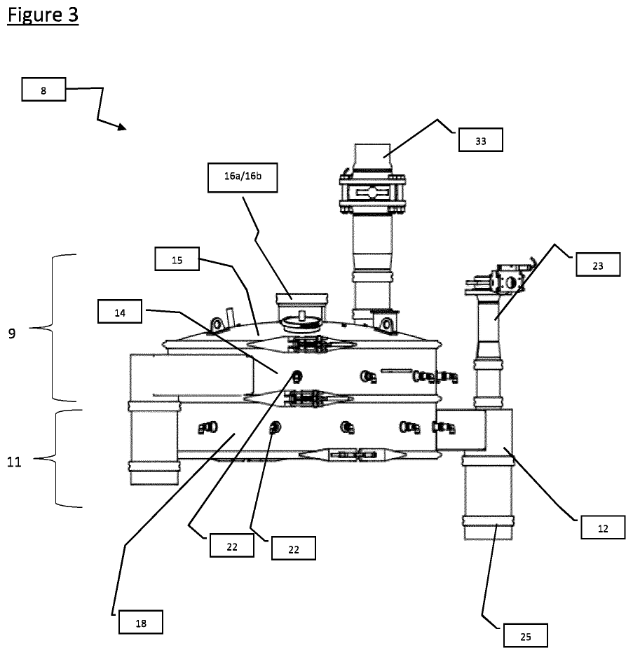

FIG. 3: shows a front view of the sieve separator of the equipment shown in FIG. 1;

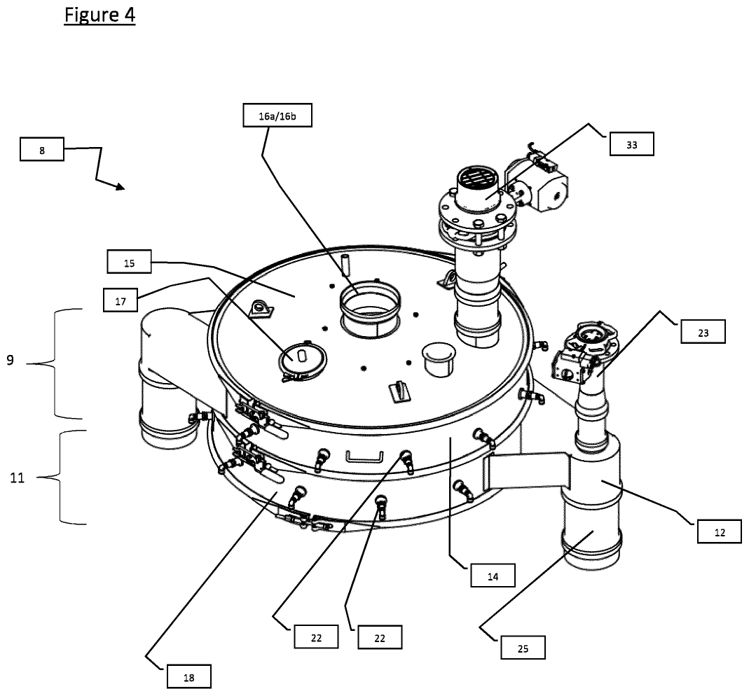

FIG. 4: shows the sieve separator of FIG. 3 in perspective top view;

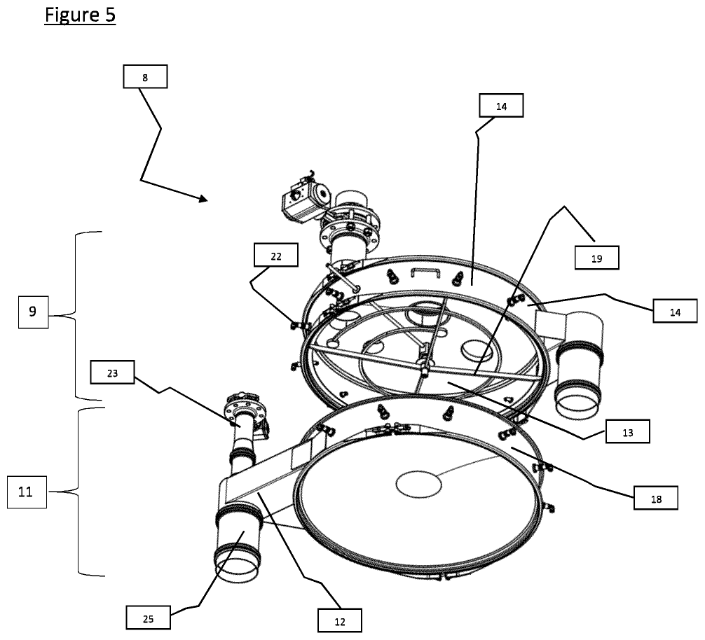

FIG. 5: shows the sieve separator of FIG. 3 in perspective bottom view.

FIG. 1 shows an arrangement of equipment 1 for the production of powder coatings. The equipment 1 comprises a mill or grinder 2 for grinding flakes of a powder coating material. Powder coating material leaving the grinder 2 has a wide particle size distribution, including superfines, oversized particles and particles within the desired particle size range. The powder coating material is transferred (arrow A) to a cyclone inlet 3 of a cyclone separator 4, where the flow of particles is separated into a central upward flow of superfines and a peripheral downward main flow. The central upward flow of the lighter superfines is caused by air suction. The superfines are discharged (arrow B) via an upper cyclone outlet 5, e.g., to a further filter station 32, e.g., with filter bags. The main flow with the heavier particles flows downward via a lower cyclone outlet 6 and a conduit 7 fluidly connected to a sieve separator 8 (arrow C).

The sieve separator 8, shown in more detail in FIGS. 3-5, comprises an upstream chamber 9, a downstream chamber 11 with an outlet 12 and a sieve 13 separating the upstream and downstream chambers 9, 11 and having an upstream surface facing the upstream chamber and a downstream surface facing the downstream chamber.

The upstream chamber 9 comprises a cylindrical peripheral side wall 14 and a lid 15 with a top inlet 16a connected to the lower cyclone outlet 6, and an observation port 17 (FIG. 4). In this example, the top inlet 16a of the upstream chamber is also the outlet 16b. The inlet/outlet 16a/16b comprises a valve selectively moveable between an inlet position (allowing powder coating to enter the sieve separator) and an outlet position (allowing discharge of powder dislodged from the surface of the sieve).

Also the downstream chamber 11 is provided with a cylindrical peripheral wall 18. The outlet 12 of the downstream chamber 11 extends tangentially from the peripheral side wall 18. The top inlet/outlet 16a/16b, the upstream chamber 9, the sieve 13, and the downstream chamber 11 are coaxially arranged about a central longitudinal axis X of the sieve separator 8 (FIG. 3).

The sieve 13 comprises a supporting frame comprising a cross support 19 (FIG. 5).

The upstream chamber 9 also comprises a second inlet 33 which comprises a valve (FIG. 2). The value is closed during sieving operation and open during cleaning to allow air flow into the sieve and prevent a vacuum being made inside the sieve.

Oversized particles are separated by the sieve 13 and remain in the upstream chamber 9. The fraction of powder coating particles within the desired particle size range passes the sieve 13 and enters the downstream chamber 11, where they are collected and discharged via the outlet 12 to a filling station 21. Here, the powder coating material is packed for further distribution.

Before production of a following batch of a different colour, the equipment 1 must be cleaned, in particular the sieve separator 8, in order to avoid contamination. FIG. 2 shows schematically the cleaning process for the sieve separator 8.

The upstream chamber 9 and downstream chamber 11 of the sieve separator 8 both comprise a series of nozzles 22 connected to a source of pressurized air or any other type of cleaning gas. The nozzles 22 are typically mounted at regular intervals in the peripheral side walls 14, 18 of the upstream and downstream chambers 9, 11 of the sieve separator, 8. The nozzles 22 are mainly oriented in a direction substantially parallel to the sieve 13, i.e so they are directed to an opposite part of the peripheral wall 14, 18 of the upstream or downstream chamber 9, 11. If the nozzles are orientated substantially parallel to the sieve and radial relative to the central axis X of the sieve separator a swirl of air across the entire sieve may be formed. However, the nozzles may also be orientated substantially parallel to the sieve and in other directions across the plane forming a number of swirls (or mini vortexes). Optionally, the nozzle direction of one or more of the nozzles 22 may be tilted relative to the sieve surface i.e. towards or away from the sieve surface. Within the confinement of the upstream or downstream chambers 9, 11 the axial and/or tangential flows will cause vortices and a swirling flow of cleaning gas over the surface of the sieve 13. The swirls loosen and lift the oversized particles left in the upstream chamber 9 of the sieve separator 8. By air suction the cleaning gas is discharged together with the particles via the outlet 16b to the lower cyclone outlet 6 to the upper cyclone outlet 5 and further to the filter station 32.

Air in the downstream chamber 11 escapes via the sieve outlet 12. The sieve outlet 12 has an upwardly directed branch 23 connected to a cleaning gas discharge line 24 (FIG. 2) and a downwardly directed branch 25 leading to the filling station 21. The sieve outlet 12 is provided with a valve which can selectively be put in a first position, guiding the flow via the downwardly directed branch to the filling station 21, and a second position to guide the flow via the cleaning gas discharge line 24 joining the discharge line/conduit of the cyclone separator 4.

The cleaning gas nozzles 22 are connected to a manifold 26 for distributing cleaning gas from a source of pressurized cleaning gas. The manifold 26 comprises several outlets 28, each comprising a valve under the control of a control unit 29. Each outlet 28 is connected to a single nozzle 22 of the sieve separator 8. When the control unit 29 opens a valve of an outlet 28, pressurized cleaning gas is jetted through the associated nozzle 22 into the upstream or downstream chamber 9, 11 of the sieve separator 8.

The control unit 29 is programmed to release the cleaning gas to each nozzle independently and pulse wise. The control unit 29 can open a number of valves simultaneously or consecutively to create a desired pattern of flows and vortices over the sieve surface. The control unit 29 can be programmed to activate the valves of the outlets 28 in a certain sequence and can be programmed to control the duration of the pulses, the duration of the time interval between the pulses and/or the flow velocity of the pulses. Optionally, the control unit 29 can also control the orientation of the nozzles 22 and the direction of the pulses. The program to be carried out by the control unit 29 may for example depend on the colour difference between two consecutive powder coating batches. If there is a strong colour contrast between the previous batch and the following batch, a more intensive program may be followed (e.g., a longer program or with longer or stronger pulses) than if the batches are only slightly different grades of the same colour. Similarly, if the preceding batch contains sticky constituents, e.g., a tacky binder component, a more intensive program may be applied.

The cleaning gas will typically be pressurized air.

It is noted that the drawings are schematic, not necessarily to scale and that details that are not required for understanding the present invention may have been omitted. The terms “upstream” and “downstream” refer to the flow direction during production, not to the flow direction of the cleaning gas during cleaning. The terms “below”, “above”, and the like relate to the embodiments as oriented in the drawings, unless otherwise specified.

The disclosure is not restricted to the above described embodiments which can be varied in a number of ways within the scope of the claims.

1. A sieve separator comprising:
an upstream chamber comprising an inlet and an outlet;
a downstream chamber comprising an outlet;
a sieve separating the upstream chamber and downstream chamber and having an upstream surface facing the upstream chamber and a downstream surface facing the downstream chamber; and
nozzles for supplying pressurized cleaning gas to the upstream chamber and downstream chamber, wherein the nozzles are positioned in the peripheral side wall of the upstream chamber and the peripheral side wall of the downstream chamber and are oriented to create a gas flow along the upstream surface and the downstream surface of the sieve.

2. The sieve separator of claim 1, wherein the inlet of the upstream chamber is the outlet of the upstream chamber, wherein the inlet of the upstream chamber comprises a valve selectively moveable between an inlet position and an outlet position.

3. The sieve separator of claim 1, wherein the nozzles are orientated to create a swirling gas flow along the upstream surface and downstream surface of the sieve.

4. The sieve separator of claim 1, wherein the upstream chamber and downstream chamber comprise a cylindrical peripheral side wall.

5. The sieve separator according to claim 1, wherein the upstream chamber comprises a second inlet.

6. The sieve separator of claim 1 comprising a control unit configured to control the nozzles to supply the cleaning gas independently and optionally pulse-wise.

7. The sieve separator of claim 6, wherein the control unit is configured to control the nozzles simultaneously or sequentially, according to programmed patterns.

8. The sieve separator according to claim 6, wherein the control unit controls one or more of the following: the direction, duration, flow velocity of the pulses, and sequence of activation of the nozzles.

9. The sieve separator of claim 1, wherein the outlet of the downstream chamber comprises a valve, selectively moveable between a sieving position, allowing discharge of sieved powder coatings to a filling station, and a cleaning position, allowing discharge of used cleaning gas.

10. An equipment for grinding powder coatings comprising a grinder comprising an outlet, a sieve separator according to claim 1, and a conduit fluidly connecting the outlet of the grinder to the inlet of the upstream chamber of the sieve separator.

11. The equipment according to claim 10, wherein the inlet of the upstream chamber is the outlet of the upstream chamber, and the conduit comprises a cyclone separator.

12. The equipment according to claim 11, wherein the cyclone separator defines a discharge flow path for used cleaning gas leaving the upstream chamber of the sieve separator.

13. A process of removing particles from a sieve separator according to claim 1, comprising:
(a) jetting cleaning gas over the upstream surface and downstream surface of the sieve from nozzles in the upstream chamber and the downstream chamber, and
(b) removing particles and cleaning gas via the outlet in the upstream chamber and the outlet in the downstream chamber.

14. The process according to claim 13, wherein the cleaning gas is jetted through different nozzles according to programmed patterns, optionally pulse wise.
